(19) United States
(12) Patent Application Publication
(10) Pub. No.: US 2006/0180453 A1
(43) Pub. Date: Aug. 17, 2006

(54) Double-pole change-over switch

(75) Inventors: Gerhard Steidle, Koenigsfeld (DE); Karl-Heinz Wohlfahrt, Bodman-Ludwigshafen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH & Co. KG

(21) Appl. No.: 11/339,131

(22) Filed: Jan. 25, 2006

(30) Foreign Application Priority Data
Jan. 31, 2005 (DE) 20 2005 001 495.8

(51) Int. Cl. H01H 13/14

(52) U.S. Cl. 200/341

(57) ABSTRACT

A change-over switch for the switching of two electric circuits is disclosed, including a housing, a tappet, two contacts of a first electric circuit, two contacts of a second electric circuit, and a switching contact which comprises in an initial state a first shape in which said first electric circuit is closed and said second electric circuit is opened, and which by actuating said tappet may be transferred into a second shape in which said first electric circuit is opened and said second electric circuit is closed.

The invention relates to a change-over switch for the switching of two electric circuits.

### BACKGROUND OF THE- INVENTION

Such change-over switches may in particular be used in motor vehicles, for example as a make/break double-throw or double switch. The designs known from the prior art are, however, comparatively expensive.

It is the object of the invention to create a change-over switch which is distinguished by particularly low manufacturing expense, redundancy and reliability, and the possibility to simultaneously switch two independent switching circuits such that at least one pair of contacts closes and one pair of contacts simultaneously opens.

### BRIEF DESCRIPTION OF THE INVENTION

In order to achieve this object, there is provided in accordance with the invention a change-over switch for the switching of two electric circuits, including a housing, a tappet, two contacts of a first electric circuit, two contacts of a second electric circuit, and a switching contact which comprises in the initial state a first shape in which the first electric circuit is closed and the second electric circuit is opened, and which by actuating the tappet may be transferred into a second shape in which the first electric circuit is opened and the second electric circuit is closed. The change-over switch in accordance with the invention is founded on the basic idea to switch two different electric circuits with one and the same switching contact and to use the transition of the switching contact from a first shape into a second one to close the contacts of a first electric circuit and open the contacts of a second electric circuit. Since only one single switching contact is required for this purpose, a simple structure which causes low manufacturing expense is achieved.

Advantageous designs of the invention will be apparent from the sub-claims.

### BRIEF DESCRIPTION OF THE DRAWINGS

The invention will be described in the following with the aid of a preferred embodiment which is represented in the accompanying drawings in which:

FIG. 1 shows a schematic section through a change-over switch in accordance with the invention;

FIG. 2 shows a section through the change-over switch of FIG. 1 rotated through 90°;

FIG. 3 schematically shows the contacts switched by the change-over switch;

FIG. 4 shows a further schematic view of the switched contacts;

FIG. 5 shows the view of FIG. 1 on an enlarged scale;

FIG. 6 shows the view of FIG. 2 on an enlarged scale;

FIG. 7 shows the view of FIG. 3 on an enlarged scale;

FIG. 8 shows a variant of an embodiment in a view corresponding to that of FIG. 7;

FIG. 9 shows a change-over switch according to a second embodiment in a view corresponding to that of FIG. 5; and

FIG. 10 shows the change-over switch according to the second embodiment in a view corresponding to that of FIG. 6.

### DETAILED DESCRIPTION OF THE INVENTION

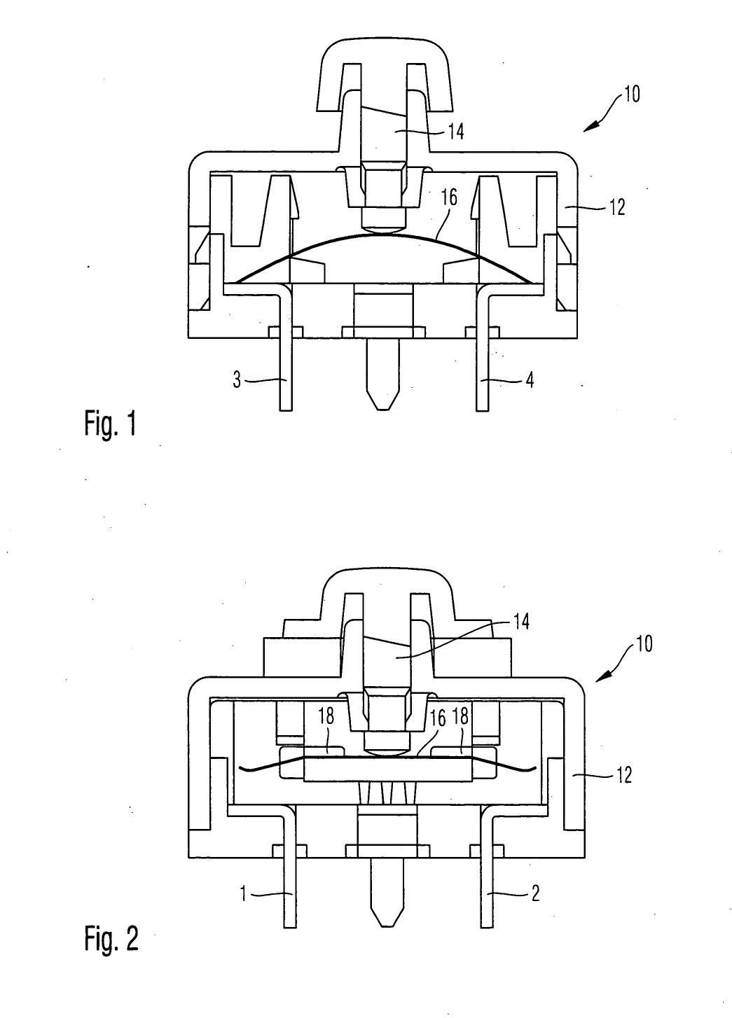

In FIGS. 1 and 2, there is shown a change-over switch 10 which comprises a housing 12 in which four contacts 1, 2, 3, and 4 to be switched are accommodated. A tappet 14 is displaceably mounted in the housing 12. The tappet 14 cooperates with a switching contact 16 that may open or close the electric contact between the two contacts 1, 2 which form a first electric circuit and the two contacts 3, 4 which form a second electric circuit.

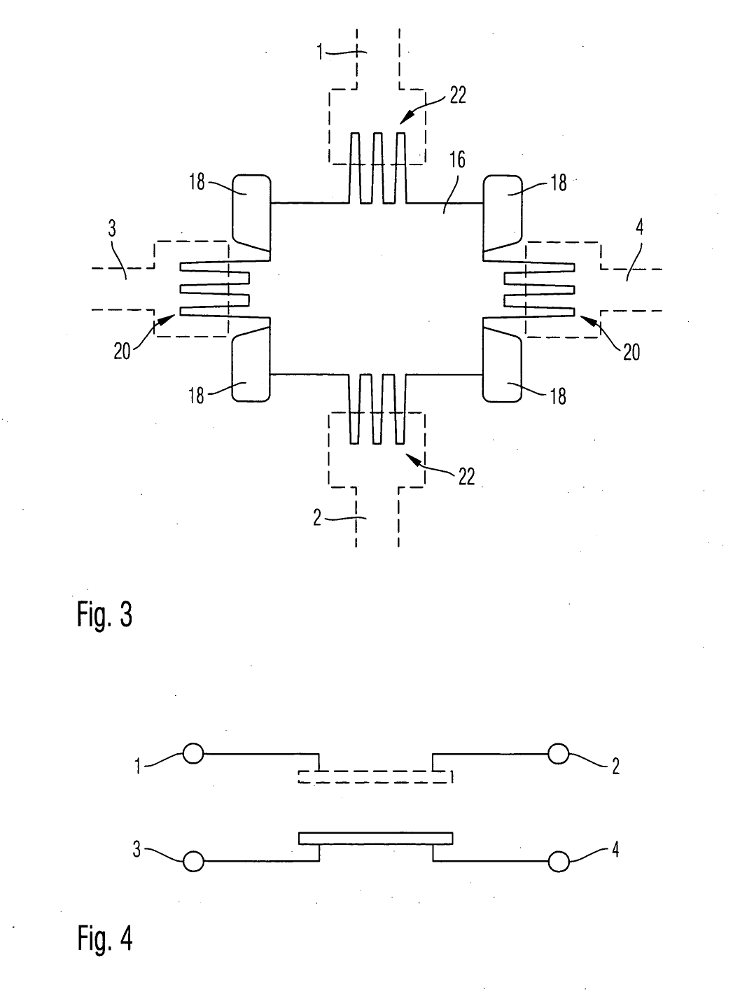

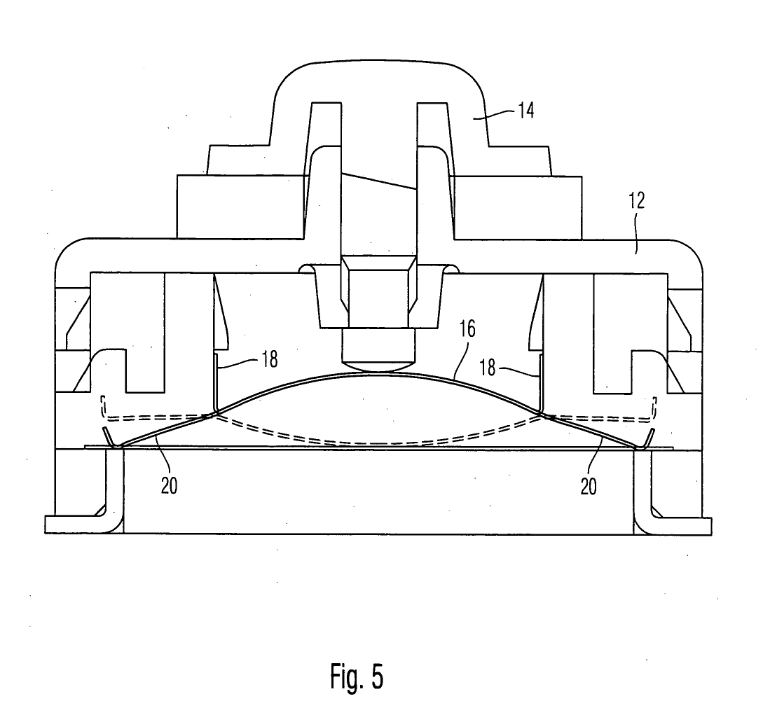

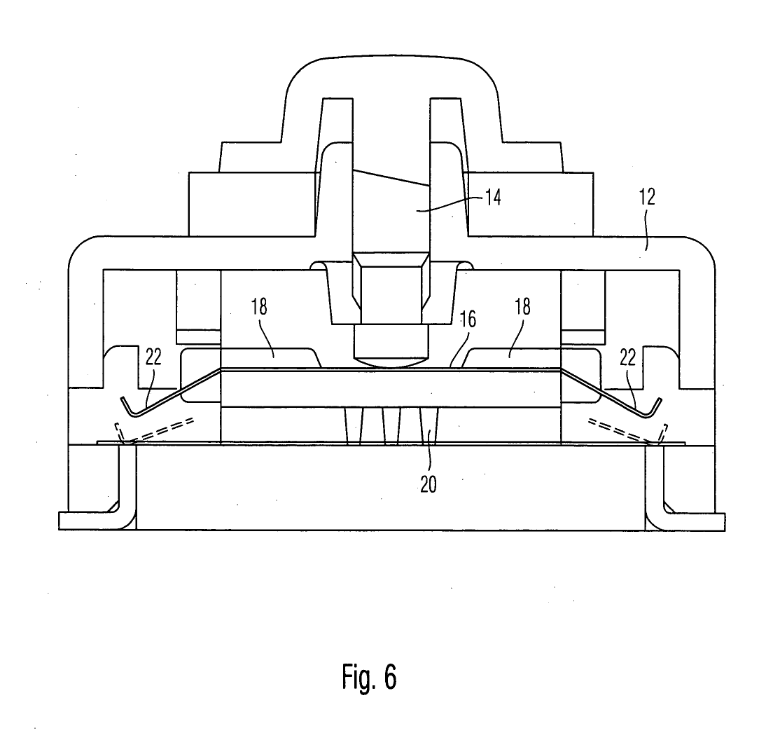

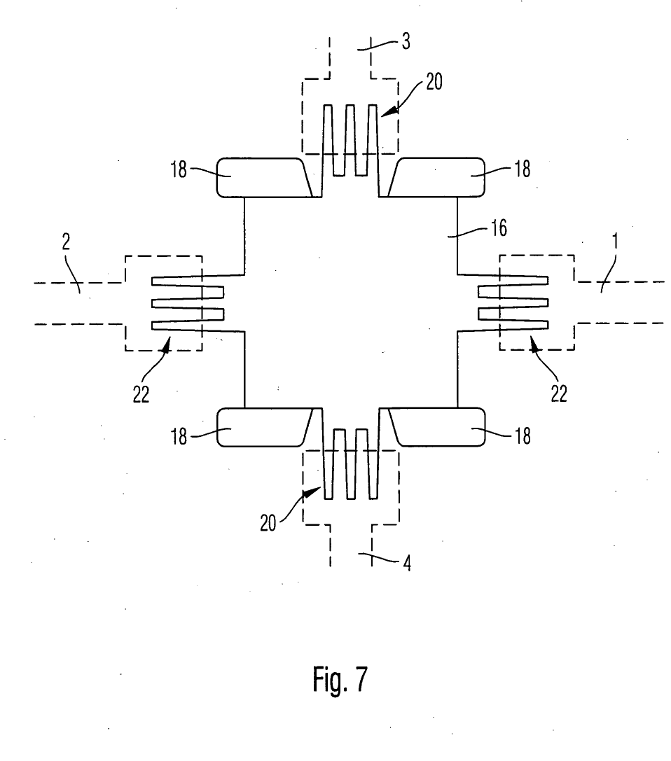

The switching contact 16 consists of spring steel sheet or another elastically resilient and electrically conductive material and has a generally rectangular basic shape (see FIG. 3). If viewed in a plane containing the contacts 3 and 4 (the representation of FIGS. 1 and 5), the switching contact 16 is arched in the initial state towards the tappet 14; it has the shape of a catch spring. Provided at the short side edges of the generally rectangular basic body of the switching contact 16 are holding lugs 18 by means of which the switching contact is attached to the housing 12. Outwardly extending between two adjacent holding lugs 18 each is one contact lug 20 each which is formed in this arrangement of 3 individual lugs each (see FIG. 3). In the initial position as shown in FIGS. 1 and 5, i.e. with the tappet 14 not being actuated, the contact lugs 20 rest against the contacts 3 and 4; thus, the electric circuit through the contacts 3 and 4 is closed (see also FIG. 4). In a plane leading through the contacts 1 and 2 (see FIGS. 2 and 6), the switching contact 16 has an approximately plane shape. Proceeding from the longer side edges of the rectangular basic body of the switching contact 16, the contact lugs 22, which are associated with the two first contacts 1, 2 and which likewise consist of a plurality of individual lugs, extend. In the initial state, i.e. when the tappet 14 is not actuated, the contact lugs 22 are spaced away from the first contacts 1, 2; thus, the first electric circuit formed by these contacts is opened.

When the tappet 14 is actuated, it presses on the center of the bow-shaped switching contact 16. The latter is transferred from its first shape, which is shown with continuous lines in FIGS. 5 and 6, into a second shape which is shown with broken lines in FIGS. 5 and 6. In the plane containing the contacts 3, 4, the switching contact 16 snaps downwards beyond a dead center against the holding force exerted by the holding lugs 18 so that the contact lugs 20 are lifted off from the contacts 3, 4; the second electric circuit formed by these contacts is thus opened (see the state of the switching contact 16 as shown in FIG. 5 in a broken line). At the same time the switching contact 16 is downwardly displaced substantially in translation in the plane containing the contacts 1, 2, so that the contact lugs 22 rest on the contacts 1, 2; the first electric circuit formed by these contacts is thus closed.

When the tappet 14 is again released, the switching contact 16 snaps back again into its first shape in which the first electric circuit formed by the contacts 1, 2 is opened and the second electric circuit formed by the contacts 3, 4 is closed.

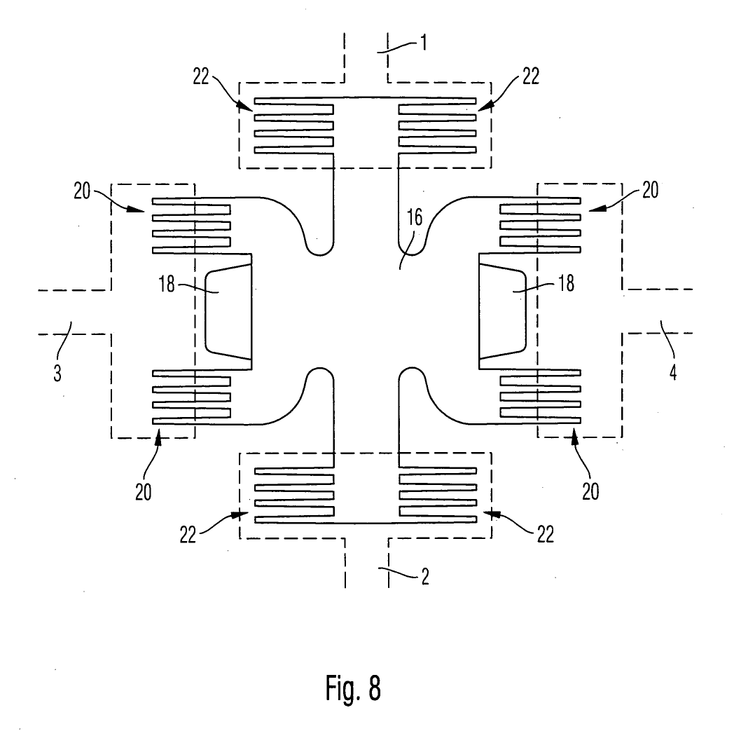

In FIG. 8, there is illustrated a variant of an embodiment which differs from the first embodiment by the deviating design of the contact lugs 20, 22. Employed for the contacts 1, 2 are two mutually opposite contact lugs 22 each, which are formed in this arrangement of four individual lugs each. Employed for the contacts 3,4 are two contact lugs 20 each, which are situated on either side of the respective holding lug 18. Each contact lug 20 in turn consists of a plurality of individual lugs. In this manner a better contact reliability when making contact is achieved.

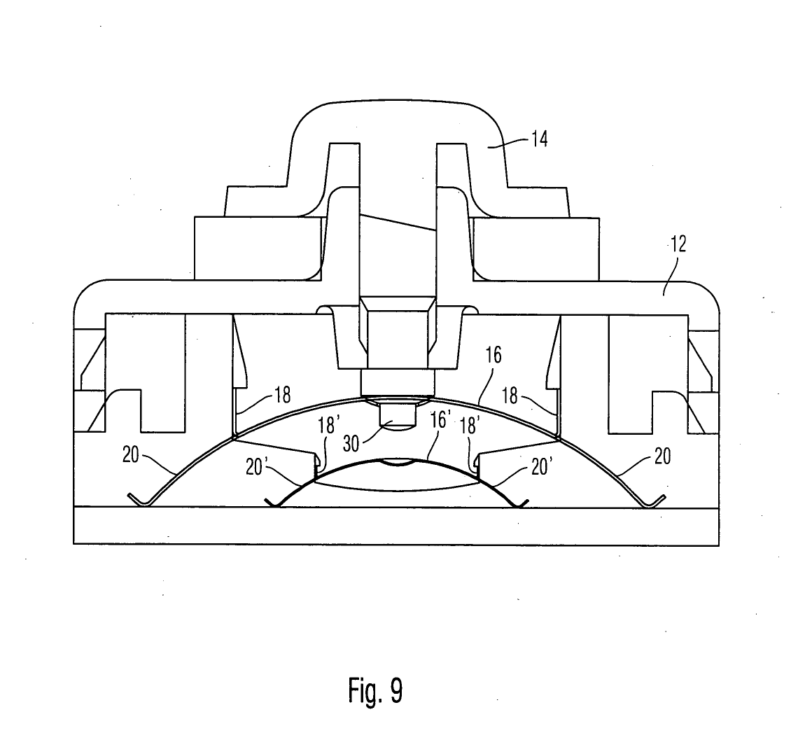

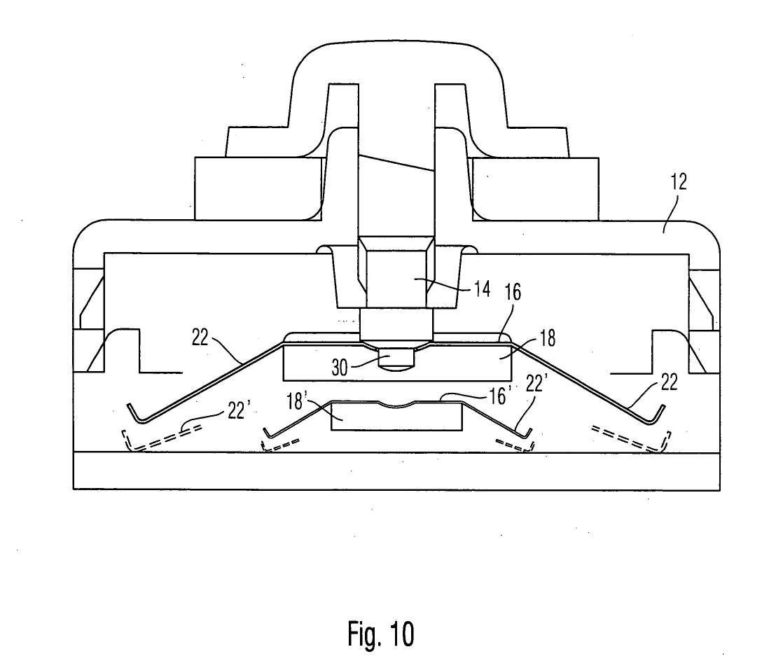

In FIGS. 9 and 10, there is shown a change-over switch according to a second embodiment. This change-over switch differs from the change-over switch according to the first embodiment by a second switching contact 16′ being disposed below the switching contact 16. With regard to its shape and its function, the second switching contact 16′ corresponds to the first switching contact 16, the difference being that the second switching contact 16′ is configured in a reduced size so that it fits below the switching contact 16. It is actuated by an extension 30 which is formed on the tappet 14 and which extends through the switching contact 16 and engages the second switching contact 16′. In this manner twice the number of contacts may simultaneously be switched.

1. A change-over switch for the switching of two electric circuits, including a housing, a tappet, two contacts of a first electric circuit, two contacts of a second electric circuit, and a switching contact which comprises in an initial state a first shape in which said first electric circuit is closed and said second electric circuit is opened, and which by actuating said tappet may be transferred into a second shape in which said first electric circuit is opened and said second electric circuit is closed.

2. The change-over switch according to claim 1, characterized in that in a plane in which the said contacts of said first electric circuit are situated said switching contact comprises in said initial state a shape arched towards said tappet.

3. The change-over switch according to claim 2, characterized in that in a plane in which said two contacts of said second electric circuit are situated said switching contact is formed like a catch spring which may snap from said initial state beyond a dead center into said second shape.

4. The change-over switch according to claim 2, characterized in that said switching contact is attached to said housing by holding lugs which are situated in said plane of said two contacts of said second electric circuit.

5. The change-over switch according to claim 4, characterized in that said switching contact is provided with two first contact lugs which, as viewed radially, are situated beyond said two holding lugs.

6. The change-over switch according to claim 5, characterized in that when said tappet is actuated said two first contact lugs are lifted off from said two contacts of said second electric circuit.

7. The change-over switch according to claim 1, characterized in that in a plane in which said two contacts of said first electric circuit are situated said switching contact comprises in said initial state a substantially plane shape.

8. The change-over switch according to claim 7, characterized in that in said plane in which said two contacts of said first electric circuit are situated said switching contact is substantially moved in translation on account of an operation of said tappet.

9. The change-over switch according to claim 7, characterized in that said switching contact comprises two second contact lugs which are pressed on said two contacts of said first electric circuit when said tappet is actuated.

10. The change-over switch according to claim 5, characterized in that said contact lugs consist of a plurality of individual lugs.

11. The change-over switch according to claim 1, characterized in that as viewed in a direction of operation of said tappet a second switching contact is disposed behind said switching contact.
